(19) United States
(12) Patent Application Publication
(10) Pub. No.: US 2004/0133817 A1
(43) Pub. Date: Jul. 8, 2004

(54) Portable computer managing power consumption according to display part positions and control method thereof

(75) Inventor: Yoon-Man Choi, Seoul City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon City (KR)

(21) Appl. No.: 10/680,167

(22) Filed: Oct. 8, 2003

(30) Foreign Application Priority Data
Jan. 2, 2003 (JP) 2003-87

(51) Int. Cl. G06F 1/26

(52) U.S. Cl. 713/300

(57) ABSTRACT

A portable computer having a main body, and a display part, which has a screen input, and capable of being opening-rotated and converting-rotated relative to the main body. A position sensor detects a converting rotation position of the display part and a controller manages power supplied to the screen input part of the display part based upon the position sensor detecting that the display part is converting-rotated into a converting rotation zone.

### CROSS-REFERENCE TO RELATED APPLICATIONS

This application claims the benefit of Korean Patent Application No. 2003-87, filed Jan. 2, 2003, in the Korean Intellectual Property Office, the disclosure of which is incorporated herein by reference.

### BACKGROUND OF THE INVENTION

1. Field of the Invention

The present invention relates to a portable computer and a control method thereof, and more particularly, to a portable computer and a control method thereof saving power supplied to a screen input part and a body input part.

2. Description of the Related Art

Generally, a user uses a portable computer with its display part having a screen unfolded. On the contrary, when the portable computer is not used or carried, its display part is folded. The operation of rotating the display part up or down relative to a main body is usually called “tilting.” Also, the display part can be rotated right and left relative to the main body, so that a screen of the display part can be toward (face) an opposite direction of the main body. The operation of rotating the display part right or left relative to the main body is called “swiveling.” The display part can also be folded onto the main body after being rotated up and then swiveled to face the screen away from the main body, so that a user can see the screen of the display part facing outside with the display part folded.

FIGS. 1A through 1D are perspective views illustrating conventional portable computers having tilting and swiveling functions. As shown in FIGS. 1A through 1D, the portable computer 1 comprises a main body 10 provided with a body input part 11, such as a keyboard 11a and a touch pad 11b, and a display part 20 displaying images on a screen 26 by receiving image signals from the main body 10.

A screen input part (not shown) of the screen 26 allows direct controlling of a pointer provided (displayed) on the screen 26 of the display part 20. If the screen 26 of the display part 25 turns toward an opposite direction of the main body 10 by being swiveled (refer to FIG. 1B and then FIG. 1C, hereinafter, defining the position of the display part 20 shown in FIG. 1C as a “rotated position”), then a user facing the screen 26 and not the body input part 11 can conveniently use the screen input part instead of the body input part 11 provided in the main body 10.

Also, as shown in FIG. 1D, if the display part 20 is folded onto the main body 10 when in the “rotated position” with the screen 26 of the display part 20 exposed outward (hereinafter, defining this position of the display part 20 shown in FIG. 1D as a “pad position”), a user can use the portable computer 1 by controlling the pointer displayed on the screen 26 using the screen input part with the portable computer 1 placed on the user's knees or a table.

However, the conventional portable computer 1 provided with the screen input part has a problem that an unnecessary power loss (consumption) occurs, because power is continuously supplied to the body input part 11, such as the keyboard 11a and the touch pad 11b, and the screen input part, regardless of a rotation state of the display part 20. For example, when the screen 26 of the display part 20 is toward (faces) the main body 10 ( i.e., the “opened position” as shown in FIG. 1A), although a user facing the screen 26 of the display part 20 rarely uses the screen input part, because the user can use the body input part 11, power is still supplied to the screen input part.

Also, when the display part 20 is rotated to the “rotated position” (FIG. 1C), although a user facing the screen 26 of the display part 20 rarely uses the body input part 11, the power is also still supplied to the body input part 11, thereby causing unnecessary power loss (consumption). Especially, when the display part 20 is in the “pad position” (FIG. 1D), although the user cannot use the body input part 11, the power is still supplied to the body input part 11, thereby causing unnecessary power loss (consumption).

### SUMMARY OF THE INVENTION

Accordingly, the present invention provides a portable computer, and a control method thereof, saving power supplied to a screen input part and a body input part according to a rotation state of a display part.

Additional aspects and advantages of the invention will be set forth in part in the description which follows and, in part, will be obvious for the description, or may be learned by practice of the invention.

The present invention may be achieved by providing a portable computer having a main body and a display part rotating open and rotating into a converted position relative to the main body, comprising a screen input part provided in a screen of the display part; a position sensor detecting a converting rotation position of the display part; and a controller controlling the screen input part to operate if the position sensor detects that the display part is rotated into a predetermined converting rotation zone.

According to an aspect of the present invention, a converting rotation of the display part includes a rotation that the screen of the display part is rotated between a position in which the screen of the display part displaying images is toward the main body and a position in which the screen of the display part is toward an opposite direction of the main body.

According to an aspect of the present invention, the portable computer further comprises a USB interface interconnecting the screen input part and the main body, wherein the controller controls the USB interface to operate in an operation mode in the case that the position sensor detects that the display part is converting-rotated into the predetermined converting rotation zone.

According to an aspect of the present invention, the controller controls the USB interface to operate in a power saving mode in the case that the position sensor detects that the display part gets out of the converting rotation zone.

According to an aspect of the present invention, the portable computer further comprises a first switching part turning on/off power supplied to the screen input part, wherein the controller turns on the first switching part in the case that the position sensor detects that the display part is converting-rotated into the converting rotation zone.

According to an aspect of the present invention, the controller turns off the first switching part in the case that the position sensor detects that the display part gets out of the converting rotation zone.

According to an aspect of the present invention, the portable computer further comprises a second switching part turning on/off power supplied to a body input part provided in the main body, wherein the position sensor detects whether the body input part is covered by the display part and the controller turns off the second switching part in the case that the position sensor detects that the body input part is covered by the display part.

According to an aspect of the present invention, the controller turns on the second switching part in the case that the position sensor detects that the body input part is open.

According to an aspect of the present invention, the portable computer further comprises a second switching part turning on/off power supplied to a body input part provided in the main body, wherein the controller turns off the second switching part in the case that the position sensor detects that the display part is converting-rotated into the predetermined converting rotation zone.

According to an aspect of the present invention, the controller turns on the second switching part in the case that the position sensor detects that the display part gets out of the predetermined converting rotation zone.

The present invention may also be achieved by providing a control method of a portable computer having a main body, a display part capable of being converting-rotated relative to the main body and a screen input part provided in a screen of the display part, comprising detecting a converting rotation position of the display body; and controlling the screen input part to operate in the case that the display part is detected to be converting-rotated into a predetermined converting rotation zone relative to the main body.

According to an aspect of the present invention, the converting rotation of the display part includes a rotation that the screen of the display part is rotated between a position in which the screen of the display part displaying images is toward the main body and a position in which the screen of the display part is toward an opposite direction of the main body.

According to an aspect of the present invention, the main body and the screen input part are connected to each other by a USB interface, and the controlling of the operation of the screen input part comprises controlling the USB interface to operate in an operation mode in the case that the display part is detected to be converting-rotated into the predetermined converting rotation zone.

According to an aspect of the present invention, the control method of the portable computer further comprises controlling the USB interface to operate in a power saving mode in the case that the display part is detected to get out of the converting rotation zone.

According to an aspect of the present invention, wherein the controlling of the operation of the screen input part comprises supplying power to the screen input part in the case that the display part is detected to be converting-rotated into the predetermined converting rotation zone.

According to an aspect of the present invention, the control method of the portable computer further comprises cutting off power supplied to the screen input part in the case that the display part is detected to get out of the predetermined converting rotation zone.

According to an aspect of the present invention, the main body is provided with a body input part having a keyboard and a touch pad; and the detecting further comprises detecting whether the body input part is covered by the display part, and cutting off power supplied to the body input part provided in the main body in the case that the body input part is detected to be covered by the display part.

According to an aspect of the present invention, the control method of the portable computer further comprises supplying power to the body input part in the case that the display part is detected to open the body input part.

According to an aspect of the present invention, the control method of the portable computer further comprises cutting off power supplied to the body input part provided in the main body in the case that the display part is detected to be converting-rotated into the predetermined converting rotation zone.

According to an aspect of the present invention, the control method of the portable computer further comprises supplying power to the body input part in the case that the display part is detected to get out of the predetermined converting rotation zone.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIGS. 1A through 1D are perspective views illustrating a conventional portable computer having tilting and swiveling functions;

FIG. 2 is a control block diagram of a portable computer having display part tilting and swiveling function, according to a first embodiment of the present invention;

FIG. 3 is a control flow diagram of the portable computer of FIG. 2;

FIG. 4 is a control block diagram of a portable computer having display part tilting and swiveling function, according to a second embodiment of the present invention;

FIG. 5 is a control flow diagram of the portable computer of FIG. 4;

FIG. 6 is a control block diagram of a portable computer having display part tilting and swiveling function, according to a third embodiment of the present invention;

FIG. 7 is a control flow diagram of the portable computer of FIG. 6;

FIG. 8 is a control block diagram of a portable computer having display part tilting and swiveling function, according to a fourth embodiment of the present invention;

FIG. 9 is a control flow diagram of the portable computer of FIG. 8; and

FIG. 10 is a control flow diagram of a portable computer having display part tilting and swiveling function, according to a fifth embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

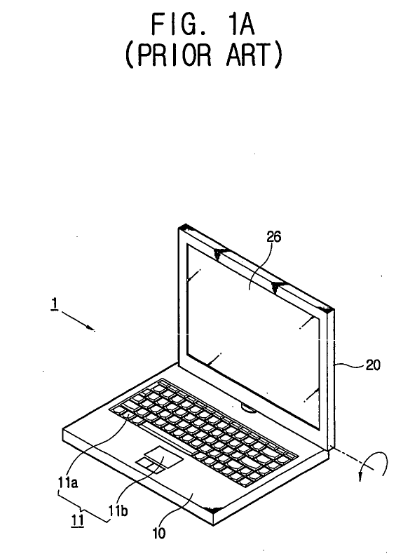

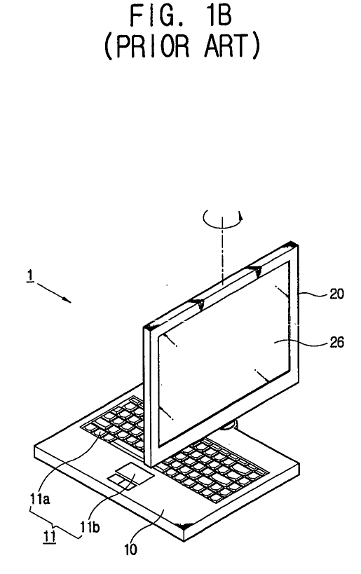

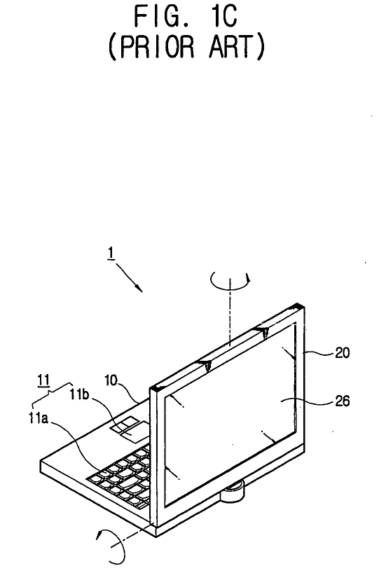

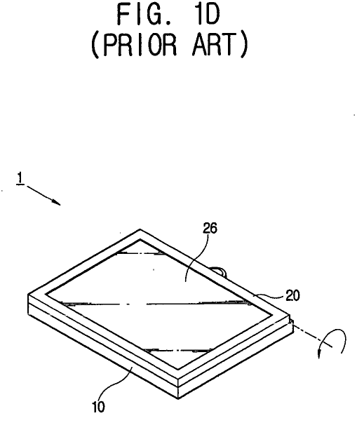

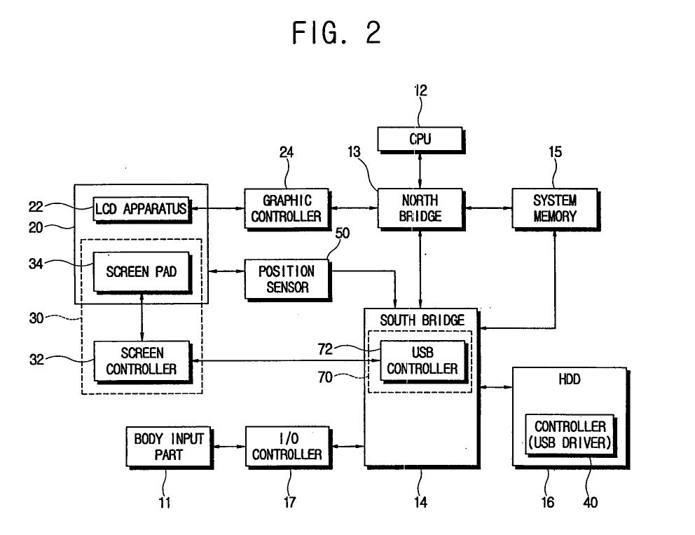

Generally, as shown in FIGS. 1A through 1D, if a portable computer includes (implements) the present invention, the portable computer comprises a main body 10 provided with a main board, an HDD and the like (refer to FIG. 2), and a display part 20 provided with an LCD apparatus (screen 26) displaying images by receiving image signals from the main body 10. Also, in the main body 10, is a body input part 11, such as a keyboard 11a and a touch pad 11b, for a key input and a pointer input, respectively.

In the portable computer implementing the present invention, the display part 20 can perform an “opening rotation” and a “converting rotation.” The “opening rotation” of the display part 20 means that the display part 20 is folded onto or unfolded from the main body 10, which is generally called “tilting.” In particular, the body input part 11 provided in the main body 10 is covered by the display part 20 if the display part 20 is folded onto the main body 10, and the body input part 11 is exposed if the display part 20 is unfolded from the main body 10.

Typically, the “converting rotation” of the display part 20 refers to converting the screen 26 viewing of the display part 20 by rotating the display part 20 to the right or left (swiveled), after being unfolded (rotated away) from the main body 10 (FIG. 1B), between a position in which the screen 26 of the display part 20 displaying images is toward the main body 10 ( the “opened position” shown in FIG. 1A) and a position in which the screen 26 of the display part 20 is toward an opposite direction of the main body 10 ( the “rotated position” shown in FIG. 1C). As shown in FIG. 1D, the “converting rotation” further comprises rotating the screen 26 of the display part 20 to be folded onto the main body 10, when the display part 20 is at the “rotated position,” thereby covering the main body 10 and maintaining exposure of the screen 26 of the display part 20 (i.e., the “pad position”).

As an example of the “opening rotation” and the “converting rotation,” FIGS. 1A through 1D illustrate an opening rotation structure that the display part 20 tilts centering around an axis of a connection part between the main body 10 and the display part 20, and a converting rotation structure that the display part 20 is rotated right and left (i.e., swiveled) relative to the main body 10. However, a structure of the display part 20 is not limited to these structures and other structural configurations can be provided to allow the screen 26 of the display part 20 to be rotated between the “opened position,” the “rotated position”, and the “pad position,” the screen 26 of the display part 20. For example, a display part supported by a supporter extended from both sides of a main body can be opening-rotated (i.e., rotated open) by rotation of the supporter, and the display part be converting-rotated (i.e., rotated into a converted position) by centering around a rotation axis of the supporter, which may be provided in a center of the supporter.

FIG. 2 is a control block diagram of a portable computer having display part tilting and swiveling functions, according to a first embodiment of the present invention. As shown in FIG. 2, the portable computer comprises a CPU 12, a system memory 15, a Northbridge 13 controlling the system memory 15 and a graphic controller 24, and a Southbridge 14 managing integratedly all kinds of input/output functions. The graphic controller 24 connected to the Northbridge 13 controls an image signal output to the LCD apparatus 22 (screen) provided in the display part 20. An auxiliary memory unit such as an HDD 16, and an I/O controller 17 controlling the body input part 11, such as the keyboard 11a and the touch pad 11b, are connected to the Southbridge 14.

Also, the portable computer according to the first embodiment of the present invention comprises a screen input part 30 provided in the display part 20, a position sensor 50 detecting the “converting rotation” of the display part 20, and a control part 40 controlling the screen input part 30 to operate if the display part 20 is detected by the position sensor 50 to be converting-rotated (i.e., if the display part 20 is rotated into a predetermined converting rotation zone). For example, the screen input part 30 can comprise a screen pad 34 provided in a front of the screen 26 of the display part 20, and a screen controller 32 converting an input signal input through the screen pad 34 as a pointer signal and the like. The screen input part 30 can be any one of device configurations allowing information input through the screen 26 of the display part 20, such as a stylus, light pen, or the like, and may include a touch screen, used to control a displayed pointer on the screen 26.

The screen input part 30 of the display part 20 and the main body 10 are connected to each other by a USB (Universal Serial Bus) interface 70, the USB providing a data communication interface as well as controlling power supply to the screen input part 30. The USB interface 70 includes a USB controller 72 mounted on the Southbridge 14. The screen input part 30 is connected to the USB controller 72 to transmit input signals input through the screen input part 30 to the main body 10. Herein, the USB controller 72 may also be mounted on the main body 10, such as a main board, and the like, as a separate chipset.

The position sensor 50 is adapted to detect a “converting rotation” position of the display part 20. In particular, the position sensor 50 is connected to the Southbridge 14, and detects whether the display part 20 is converting-rotated into the converting rotation zone or getting out of the converting rotation zone. The control part 40 according to the first embodiment of the present invention is a USB driver 40 controlling the USB interface 70 to operate in an operating mode and a power saving mode. Typically, the USB driver 40 can be provided as an application, which is stored in an auxiliary memory unit, such as the HDD 16 and the like, and based on (compatible with) an operating system, or as part of a BIOS stored in a BIOS ROM. The USB driver 40 controls the USB controller 72 to operate in the operation mode and the power saving mode according to a “converting rotation” position of the display part 20 as detected by the position sensor 50, and information thereof is transmitted through the south bridge 14 to the USB driver 40.

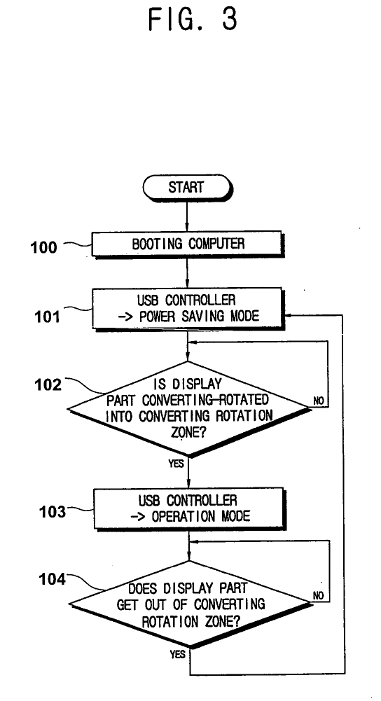

With the above configuration, a control method of the portable computer shown in FIG. 2 is described with reference to FIG. 3. At operation 100, the display part 20 is rotated to the “opened position,” in which the display part 20 is unfolded relative to the main body 10 and the portable computer is booted by turning on a power switch of the portable computer. When, at operation 100, the portable computer is booted, at operation 101, the USB driver 40 controls the USB controller 72 to operate in the power saving mode. Accordingly, if the display part 20 is in the “opened position,” power supplied to the screen input part 30 of the display part 20, which may be rarely used, is minimized, because typically, in the “opened position” a user inputs predetermined data through the body input part 11.

Subsequently, if the display part 20 is rotated into the “converting rotation” zone (FIGS. 1C and 1D) by being converting-rotated from the “opened position” (FIG. 1A) to the “rotated position” (FIG. 1C) or to the “pad position” (FIG. 1D) by a user, at operation 102, the position sensor 50 detects that the display part 20 is rotated into the “converting rotation” zone. If determined at operation 102, that the display part 20 is in the “converting rotation” zone, the USB driver 40 converts the power saving mode of the USB controller 72 to an operating mode. Accordingly, at operation 103, the screen input part 30 connected to the USB controller 72 operates, so that a user facing the screen 26 of the display part 20 can input data through the screen input part 30.

If, at operation 104, the display part 20 gets out of the “converting rotation” zone (FIGS. 1C and 1D) by being converting-rotated from the “rotated position” (FIG. 1C) or the “pad position” (FIG. 1D) to the “opened position” (FIG. 1A) by a user, the position sensor 50 detects that the display part 20 is out of the “converting rotation” zone. Once, at operation 104, the display part 20 is detected to be out of the “converting rotation” zone by the position sensor 50, at operation 101, the USB driver 40 converts the mode of the USB controller 72 from the operating mode to the power saving mode. Thus, when a user faces both the screen 26 of the display part 20 and the body input part 11, the mode of the USB controller 72 is converted to the power saving mode, thereby minimizing unnecessary power supplied to the screen input part 30.

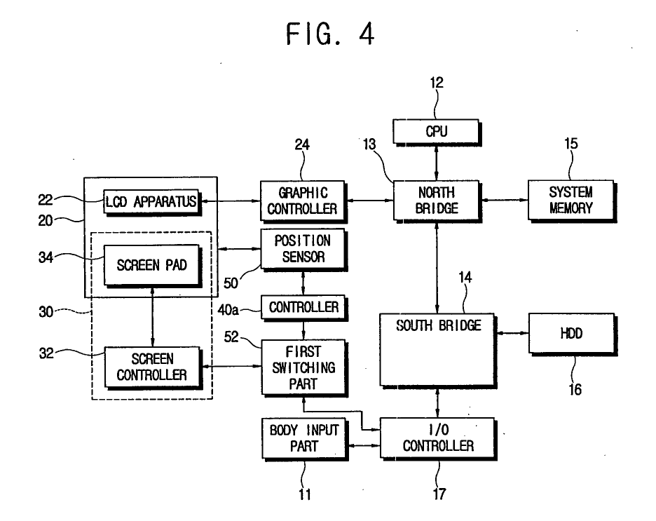

FIG. 4 is a control block diagram of a portable computer having display part tilting and swiveling functions, according to a second embodiment of the present invention. As shown in FIG. 4, the portable computer comprises a first switching part 52 turning on/off power supplied to the screen input part 30. The screen controller 32 of the screen input part 30 is connected, via the first switching part 52, to the I/O controller 17 and transmits an input signal input through the screen pad 34 to the main body 10. In particular, the first switching part 52 is provided between the screen input part 30 and the I/O controller 17, and turns on/off power supplied to the screen input part 30. A controller 40a between the position sensor 50 and the first switching part 52 controls the first switching part 52 according to positions of the display part 20 as detected by the position sensor 50.

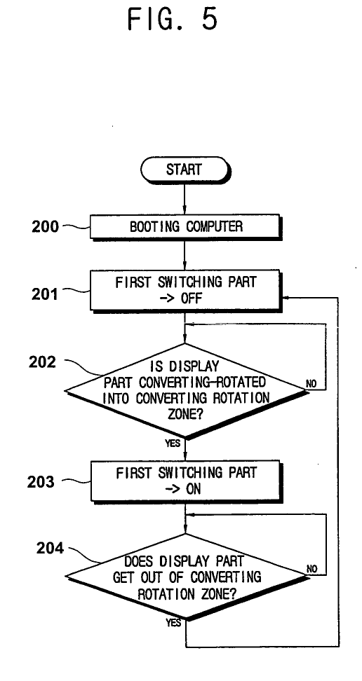

FIG. 5 is a control flow diagram of the portable computer of FIG. 4. At operation 200, the portable computer is booted, and after the booting, at operation 201, the first switching part 52 is maintained off. If the display part 20 is converting-rotated from the “opened position” to the “rotated position” or the pad position”, at operation 202, the position sensor 50 detects that the display part 20 is rotated into the “converting rotation” zone (FIGS. 1C and 1D). If determined at operation 202 that the display part 20 is in the “converting rotation” zone, at operation 203, the controller 40a turns on the first switching part 52. Also, if the display part 20 is converting-rotated from the “rotated position” or the pad position” to the “opened position”, at operation 204, the position sensor 50 detects that the display part 20 is out of the “converting rotation” zone and, at operation 201, the controller 40a turns off the first switching part 52. Thus, only when the display part 20 is in the “rotated position” or the pad position”, that is, when the screen 26 of the display part 20 is toward the opposite direction of the main body 10, power is supplied, via the first switching part 52, to the screen input part 30, thereby minimizing unnecessary power consumption.

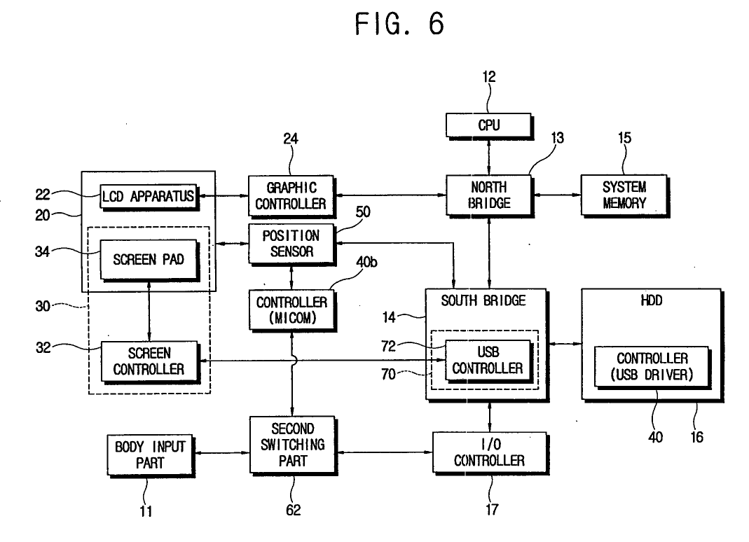

FIG. 6 is a control block diagram of a portable computer having tilting and swiveling functions, according to a third embodiment of the present invention. In FIG. 6, the portable computer has a control configuration based upon the portable computer according to the first embodiment shown in FIG. 2, and further comprises a second switching part 62 turning on/off power supplied to the body input part 11 provided in the main body 10. Also, the position sensor 50 detects whether the body input part 11 is covered by the display part 20. A controller 40b between the position sensor 50 and the second switching part 62 controls the second switching part 62 according to positions of the display part 20 as detected by the position sensor 50. For example, if the position sensor 50 detects that the body input part 11 is covered by the display part 20, the controller 40b turns off the second switching part 62. Further, if the position sensor 50 detects that the body input part 11 is open, the controller 40b turns on the second switching part 62. Typically, the controller 40 is the USB driver 40 controlling the USB controller 72 to operate the screen input part 30 in the power saving mode and the operation mode, and the controller 40b is a micro controller 40b turning on/off the second switching part 62, according the position sensor 50 position signals.

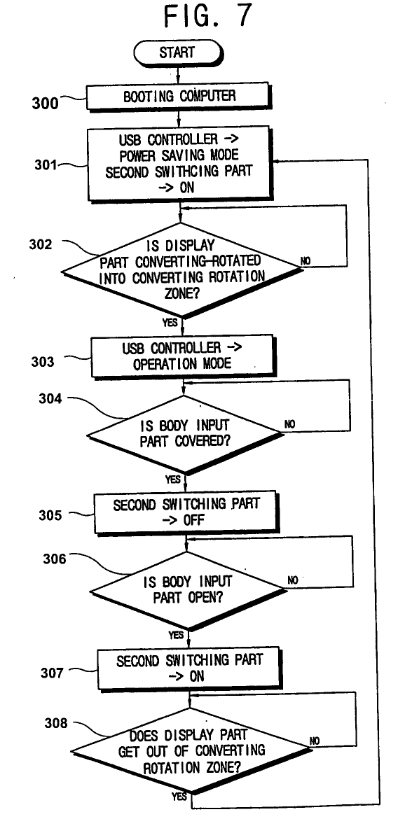

A control process of the portable computer shown in FIG. 7 will be described with reference to FIG. 7. At operation 300, to use the portable computer, a user opening-rotates the display part 20 to the “opened position,” in which the display part 20 is unfolded relative to the main body 10, and boots the portable computer by turning on a power switch of the portable computer. When, at operation 300, the portable computer is booted, at operation 301, the USB driver 40 controls the USB controller 72 to operate in the power saving mode, thereby minimizing power supplied to the screen input part 30 which may be rarely used when the display part 20 is in the “opened position.” At operation 301, because typically the user inputs predetermined data through the body input part 11, the second switching part 62 is maintained on.

Subsequently, if the display part 20 is rotated into the “converting rotation” zone by being converting-rotated from the “opened position” to the “rotated position” by a user, at operation 302, the position sensor 50 detects that the display part 20 is rotated into the “converting rotation” zone. If determined at operation 302, that the display part 20 is rotated into the “converting rotation” zone, at operation 303, the USB driver 40 converts the mode of the USB controller 72 from the power saving mode to the operation mode. Thus, at operation 303, the screen input part 30 connected to the USB controller 72 operates, so that a user facing the screen 26 of the display part 20 can input predetermined data through the screen input part 30. Also, a user can input the predetermined data through the body input part 11 as necessary.

Also, subsequently, if a user further converting-rotates the display part 20 from the “rotated position” to the “pad position,” so that the body input part 11 is covered by the display part 20, with the screen 26 of the display part 20 exposed outward, at operation 304, the position sensor 50 detects that the body input part 11 is covered. If determined at operation 304, that the body input part 11 is covered by the display part 20, at operation 305, the microcontroller 40b turns off the second switching part 62. Thus, at operation 305, because a user inputs data through the screen input part 30, and power supplied to the body input part 11 covered by the display part 20 is cut off, If determined at operation 306, that a user is rotating the display part 20 from the “pad position” back to the “rotated position,” and thus, opens the body input part 11, at operation 307, the microcontroller 40b turns on the second switching part 62 again, allowing the user to use the body input part 11 as necessary.

If a user further rotates the display part 20 from the “rotated position” back to the “opened position,” so that the display part 20 gets out of the “converting rotation” zone, at operation 308, the position sensor 50 detects that the display part 20 is out of the “converting rotation” zone. If, at operation 308, the position sensor 50 detects that the display part 20 is out of the converting rotation zone, at operation 301, the USB driver 40 converts the mode of the USB controller 72 from the operating mode to the power saving mode. Thus, when the user is facing the screen 26 of the display part 20 in a position where the user can use the body input part 11, the mode of the USB controller 72 is converted to the power saving mode, thereby minimizing unnecessary power supplied to the screen input part 30.

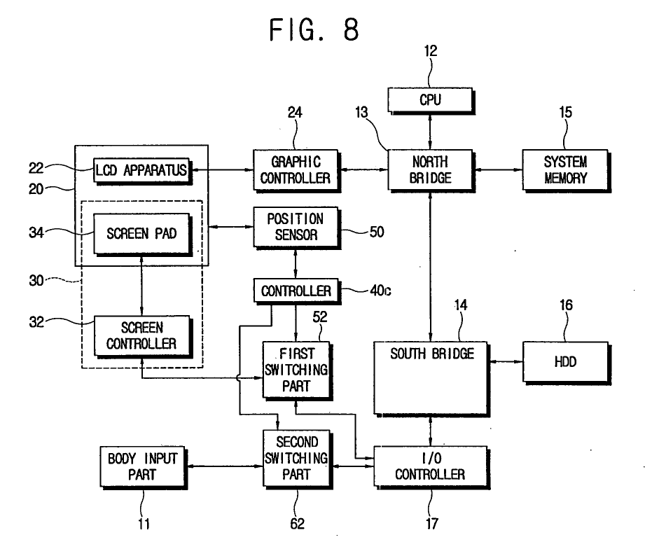

FIG. 8 is a control block diagram of a portable computer having display part tilting and swiveling functions, according to a fourth embodiment of the present invention. In FIG. 8, the portable computer has a control configuration based upon the portable computer according to the second embodiment shown in FIG. 4, and further also comprises the second switching part 62 turning on/off power supplied to the body input part 11 provided in the main body 10. Also, the position sensor 50 detects whether the body input part 11 is covered by the display part 20. A controller 40c between the position sensor 50 and the second switching part 62 controls the second switching part 62 according to positions of the display part 20 as detected by the position sensor 50. In particular, the controller 40c turns off the second switching part 62 if the position sensor 50 detects that the body input part 11 is covered by the display part 20. Also, the controller 40c turns on the second switching part 62 if the position sensor 50 detects that the body input part 11 is open.

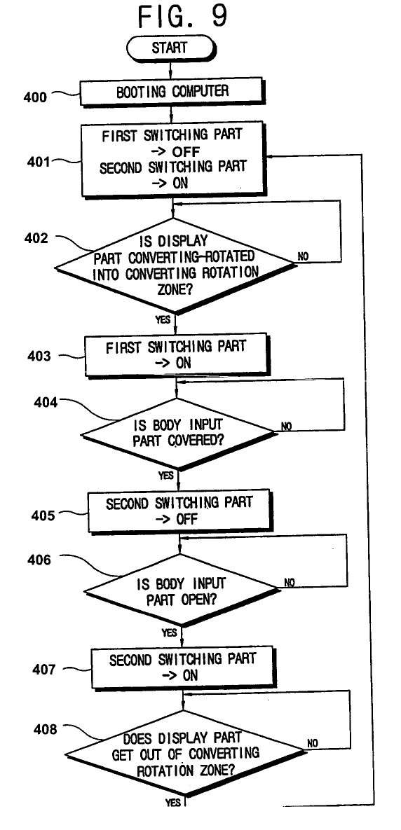

A control process of the portable computer shown in FIG. 8 will be described with reference to FIG. 9. At operation 400, the portable computer is booted, and after the booting, at operation 401, the first switching part 52 is maintained off. If the display part 20 is converting-rotated from the “opened position” to the “rotated position,” at operation 402, the position sensor 50 detects that the display part 20 is rotated into the “converting rotation” zone. If determined at operation 402, that the display part is in the “converting rotation” zone, at operation 403, the controller 40c turns on the first switching part 52.

If a user further converting-rotates the display part 20 from the “rotated position” to the “pad position,” so that the body input part 11 is closed (covered) by the display part 20 with the screen 26 of the display part 20 exposed outward, at operation 404, the position sensor 50 detects that the body input part 11 is closed. If determined at operation 404, that the body input part 11 is covered by the display part 20, at operation 405, the controller 40c turns off the second switch part 62. Also, if determined at operation 406, that a user is rotating the display part 20 back from the “pad position” to the “rotated position,” so that the body input part 11 is open, at operation 407, the controller 40c turns on the second switching part 62 again when the body input part 11 is detected to be open. Subsequently, if the display part 20 is further rotated from the “rotated position” to the “opened position,” and, at operation 408, the position sensor 50 detects that the display part 20 is out of the “converting rotation” zone, at operation 401, the controller 40c turns off the first switching part 52.

According to a fifth embodiment of the present invention to control the portable computer shown in FIG. 8, if, at operation 402, the position sensor 50 detects that the display part 20 is rotated into the “converting rotation” zone, at operation 403, the controller 40c also turns off the second switching part 62. Also, if, at operation 408, the position sensor 50 detects that the display part 20 is out of the “converting rotation” zone, at operation 401, the controller 40c turns on the second switching part 62.

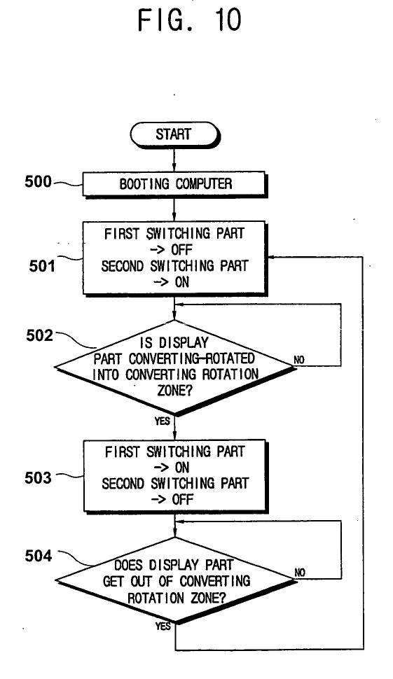

FIG. 10 is a control flow diagram of the portable computer according to the fifth embodiment. At operation 500, to use the portable computer, a user open-rotates the display part 20 to the “opened position,” in which the display part 20 is unfolded relative to the main body 10, and boots the portable computer by turning on a power switch of the portable computer. When the portable computer is booted, at operation 501, the controller 40c cuts off power supplied to the screen input part 30 by controlling the first switching part 52 to be maintained off, and allows power to be supplied to the body input part 11 by controlling the second switching part 62 to be maintained on. Thus, at operation 501, when a user is facing the screen 26 of the display part 20, the user inputs predetermined data through the body input part 11 with the display part 20 being in the “opened position,” and power consumption is decreased by cutting off power supplied to the screen input part 30, which will be rarely used.

Subsequently, if the display part 20 is rotated into the “converting rotation” zone by being converting-rotated from the “opened position” to the “rotated position” by a user, at operation 502, the position sensor 50 detects that the display part 20 is rotated into the “converting rotation” zone. If, at operation 502, the position sensor 50 detects that the display part 20 is rotated into the “converting rotation” zone, at operation 503, the controller 40c allows power to be supplied to the screen input part 30 by turning on the first switching part 52 and cuts off power supplied to the body input part 11 by turning off the second switching part 62. Thus, when the display part 20 is in the “rotated position,” a user facing the screen 26 of the display part 20 can input predetermined data through the screen input part 30, and power consumption can be decreased by cutting off unnecessary power supplied to the body input part 11, which may be rarely used.

Subsequently, if a user rotates the display part 20 from the “rotated position” back to the “opened position”, at operation 504, the position sensor 50 detects that the display part 11 is out of the “converting rotation” zone. If, at operation 504, the position sensor 50 detects that the display part 11 is out of the “converting rotation” zone, at operation 501, the controller 40c cuts off power supplied to the screen input part 30 by turning off the first switching part 52 and allows power to be supplied to the body input part 11 by turning on the second switching part 62. Thus, a user facing the screen 26 of the display part 20 can use the body input part 11 when the display part 20 is in the “opened position,” and power loss is decreased by cutting off power supplied to the screen input part 30, which may be rarely used.

In the above embodiments, according to whether the display part 20 is rotated into or out of the “converting rotation” zone, the controller (40, 40a, 40c) controls the first switching part 52 and the USB controller 72. However, specifically, the controller (40, 40a, 40c) controls the first switching part 52 and the USB controller 72 according to whether the display part is in the “rotated position” or the “opened position.” In the third, fourth or fifth embodiments of the present invention, the position sensor 50 detects both whether the display part 20 converting-rotates and whether the body input part 11 is covered by the display part 20, so that the controller (40b, 40c) can control the second switching part 62 according to whether the display part 20 is in the “pad position.”

Although the control flow according to the fifth embodiment of the present invention is implemented in the configuration of the portable computer according to the fourth embodiment shown in FIG. 8, such a configuration is an example, and the control flow of the fifth embodiment of the present invention can be implemented in the configuration of the portable computer according to the third embodiment shown in FIG. 6.

In the above embodiments, the controllers 40 and 40c control the first switching part 52 and the USB controller 72 corresponding to whether the display part 20 is converting-rotated into or out of the “converting rotation” zone, but the controllers 40 and 40c can also be implemented according to a configuration to control the second switching part 62 and the USB controller 72 corresponding to whether the display part is in the “rotated position” or the “open position.”

In the above embodiments, the display part 20 is rotated from the “rotated position” and then to the “pad position,” and thus the body input part 11 is cut off from the outside (i.e., covered) by the display part 20 with the screen 26 of the display part 20 exposed outward. However, the display part 20 can be moved to the “pad position” without moving through the “opened position” and/or the “rotated position,” as in the case when the display part 20 is supported by the support extending from both sides of the main body 10. Accordingly, whenever the display part is moved to the “pad position” in which the body input part is cut off from the outside, the controller 40b, 40c turns off the second switching part 62 so that the power supplied to the body input part 11 can be cut off.

Therefore, according to the present invention, power supplied to the screen input part 30 can be saved by providing the screen input part 30 in the screen 26 of the display part 20, the position sensor 50 detecting the converting rotation of the display part 20, and the controller 40, 40a and 40c controlling the screen input part 30 to operate if the position sensor 50 detects that the display part 20 is converting-rotated into a predetermined “converting rotation” zone. Also, power can be saved by cutting off power supplied to the body input part 11, which may be rarely used, by turning off the second switching part 62, which turns on/off power supplied to the body input part 11 provided in the main body 10, if the position sensor 50 detects that the display part 20 is in the “pad position” of the “converting-rotation” zone.

As described above, the present invention provides a portable computer, and a control method thereof, to manage power supplied to a screen input part of a rotatable (for example, tilting and swiveling) display part and a body input part (i.e., manage power consumption), according to viewing positions of the display part relative to the body input part. The processes of the invention as shown in FIGS. 3, 5, 7, 9 and 10, and implemented in a portable computer as shown in FIGS. 2, 4, 6 and 8, can be implemented in software and/or computing hardware.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A portable computer having a main body and a display part opening-rotatable and converting-rotatable relative to the main body, comprising:
a screen input part provided in a screen of the display part;
a position sensor detecting a converting rotation of the display part; and
a controller controlling the screen input part to operate if the position sensor detects that the display part is in a converting rotation zone.

2. The portable computer according to claim 1, wherein the converting rotation of the display part is a rotation of the display part between a position in which the screen of the display part displaying images is toward the main body and a position in which the screen of the display part is toward an opposite direction of the main body.

3. The portable computer according to claim 2, further comprising a Universal Serial Bus (USB) interface interconnecting the screen input part and the main body, wherein the controller controls the USB interface to operate in an operation mode if the position sensor detects that the display part is converting-rotated into the converting rotation zone.

4. The portable computer according to claim 3, wherein the controller controls the USB interface to operate in a power saving mode if the position sensor detects that the display part is out of the converting rotation zone.

5. The portable computer according to claim 2, further comprising a first switching part turning on/off power supplied to the screen input part, wherein the controller turns on the first switching part if the position sensor detects that the display part is converting-rotated into the converting rotation zone.

6. The portable computer according to claim 5, wherein the controller turns off the first switching part if the position sensor detects that the display part is out of the converting rotation zone.

7. The portable computer according to claim 2, further comprising a second switching part turning on/off power supplied to a body input part provided in the main body, wherein the position sensor detects whether the body input part is covered by the display part and the controller turns off the second switching part if the position sensor detects that the body input part is covered by the display part.

8. The portable computer according to claim 7, wherein the controller turns on the second switching part if the position sensor detects that the body input part is uncovered.

9. The portable computer according to claim 2, further comprising a second switching part turning on/off power supplied to a body input part provided in the main body, wherein the controller turns off the second switching part if the position sensor detects that the display part is converting-rotated into the converting rotation zone.

10. The portable computer according to claim 9, wherein the controller turns on the second switching part if the position sensor detects that the display part is out of the converting rotation zone.

11. A method of controlling a portable computer having a main body, a display part capable of being converting-rotated relative to the main body, and a screen input part provided in a screen of the display part, comprising:
detecting a converting rotation of the display body; and
controlling the screen input part to operate, if detected that the display part is in a converting rotation zone relative to the main body.

12. The control method of the portable computer according to claim 11, wherein the converting rotation of the display part is a rotation of the display part between a position in which the screen of the display part displaying images is toward the main body and a position in which the screen of the display part is toward an opposite direction of the main body.

13. The control method of the portable computer according to claim 12, wherein the main body and the screen input part are connected to each other by a Universal Serial Bus (USB) interface, and the controlling of the operation of the screen input part comprises controlling the USB interface to operate in an operation mode if the display part is detected to be converting-rotated into the converting rotation zone.

14. The control method of the portable computer according to claim 13, further comprising controlling the USB interface to operate in a power saving mode if the display part is detected to be out of the converting rotation zone.

15. The control method of the portable computer according to claim 12, wherein the controlling of the operation of the screen input part comprises supplying power to the screen input part if the display part is detected to be converting-rotated into the converting rotation zone.

16. The control method of the portable computer according to claim 15, further comprising cutting off power supplied to the screen input part if the display part is detected to be out of the converting rotation zone.

17. The control method of the portable computer according to claim 12, wherein the main body is provided with a body input part having a keyboard and a touch pad, and the detecting further comprises detecting whether the body input part is covered by the display part, and cutting off power supplied to the body input part provided in the main body if the body input part is detected to be covered by the display part.

18. The control method of the portable computer according to claim 17, further comprising supplying power to the body input part if the display part is detected not to cover the body input part.

19. The control method of the portable computer according to claim 12, further comprising cutting off power supplied to the body input part provided in the main body if the display part is detected to be converting-rotated into the converting rotation zone.

20. The control method of the portable computer according to claim 19, further comprising supplying power to the body input part if the display part is detected to be out of the converting rotation zone.

21. A portable computer having a main body and a display part rotatable relative to the main body, comprising:
a screen input part provided in a screen of the display part;
a body input part provided in the main body; and
a controller managing power supplied to the screen input part and the body input part according to rotated viewing positions of the display part screen relative to the body input part.

22. The portable computer of claim 21, wherein one of the rotated viewing positions of the display part screen is a swiveled position with the screen facing away from the main body.

23. The portable computer of claim 22, wherein one of the viewing positions of the display part screen is a pad position with the display part covering the body input part and the screen exposed.

24. The portable computer of claim 22, wherein the controller comprises:
a position sensor detecting the viewing positions of the display part; and
a Universal Serial Bus interface interfacing with the screen control part according to the rotated viewing positions detected by the position sensor.

25. The portable computer of claim 22, wherein the controller comprises:
a position sensor detecting the viewing positions of the display part and covering of the body input part by the display part; and
a micro controller controlling the power supplied to the screen control part and the body input part according to the rotated viewing positions detected by the position sensor.

26. The portable computer of claim 22, wherein the controller comprises:
a position sensor detecting the viewing positions of the display part; and
a Universal Serial Bus interface interfacing with the screen control part and controlling power supplied to the body input part, according to the rotated viewing positions detected by the position sensor.

27. A method of managing power in a portable computer having a main body with a body input part and a converting-rotatable display part with a screen input part, comprising:
detecting a converting-rotation zone of the display part; and
managing power supplied to the screen input part and the body input part according to the detecting of the converting-rotation zone.
